(19) United States
(12) Patent Application Publication
(10) Pub. No.: US 2010/0224636 A1
(43) Pub. Date: Sep. 9, 2010

(54) Performance test methods for cookware

(76) Inventors: Elisha Etheridge, Lawrenceville, GA (US); Paul Loguidice, Atlanta, GA (US); Lyle Stiles, Whitehouse, OH (US)

Correspondence Address: GARDNER GROFF GREENWALD & VILLANUEVA, PC, 2018 POWERS FERRY ROAD, SUITE 800, ATLANTA, GA, 30339, US

(21) Appl. No.: 12/660,740

(22) Filed: Mar. 3, 2010

Related U.S. Application Data
(60) Provisional application No. 61/157,421, filed on Mar. 4, 2009.

(51) Int. Cl. A47J 27/00; G01N 31/00

(52) U.S. Cl. 220/573.1; 436/2; 436/164

(57) ABSTRACT

Test methods are provided for evaluating the performance of cookware. One example test evaluates the durability of the cookware's grate-contacting surface, and includes a heat-abrasion phase on a cooking device's grate, a food-baking phase using a cooking-surface staining food item and/or a common food-cooking substance, and/or a solution-soaking phase using a caustic solution. Another example test evaluates the release performance of the cookware's cooking surface, and includes a release phase using a food item that tends to stick to cooking surfaces, a food-baking phase using salt and grease, a tiger paw phase, and/or an automatic dishwasher phase. And another example test evaluates the searing performance of the cookware's cooking surface, and includes searing a piece of meat on the cooking surface and evaluating the color/darkness of the meat piece itself and/or a fond made from the cooked-on meat residue against standardized colors/darknesses.

### CROSS-REFERENCE TO RELATED APPLICATIONS

This application claims the priority benefit of U.S. Provisional Patent Application Ser. No. 61/157,421, filed Mar. 4, 2009, which is hereby incorporated herein by reference.

### TECHNICAL FIELD

The present invention relates generally to cookware and, in particular, to test methods for determining the performance of cookware.

### BACKGROUND OF THE INVENTION

It can be said that there are two types of cooks: those who don't put much effort into cooking because “food is just food,” and the fun, adventurous cooks who thrive on the creative inspirations of the kitchen. For the avid cook, high-quality cookware is a must. There are a number of companies that manufacture high-quality cookware. But there are few known methods for accurately, consistently, and practically testing the performance of high-quality cookware.

This can be a problem because, for example, it might be desirable to offer a lifetime guarantee on cookware. But there are few known practical ways to effectively and accurately test cookware to determine its useful life. Known performance test methods that are currently available involve manually subjecting the cookware to, for example, several years worth of use. These sometimes include washing the cookware in an automatic dishwasher over and over to simulate in a shorter period of time the use that could be expected in a number of years. These also sometimes include a “tiger paw” test of the durability of the inside coating of the cookware. But these test methods require much time and effort to perform, and do not always yield accurate and consistent results.

In addition, there are known methods of testing non-stick cookware for its ability to “release” food cooked in it. For example, it is known to perform a “dry egg” test of the ability of the non-stick inside surface of cookware to release an egg cooked in the cookware. But this test method by itself is not satisfactory to evaluate the true performance of cookware.

Accordingly, it can be seen that needs exist for improvements to methods for testing cookware to evaluate the cookware's performance. It is to the provision of solutions to this and other problems that the present invention is primarily directed.

### SUMMARY

Generally described, the present invention relates to innovative test methods that can be used to evaluate the performance of cookware. The methods can be used to test the performance of a variety of types of cookware such as pots, pans, skillets, griddles, dishes, bowls, woks, and/or lids therefor.

A first example method according to the invention is an accelerated-time test method for evaluating the durability of the exterior bottom surface of a cookware test specimen. The method includes a solution-soaking test phase using a caustic solution made with a caustic compound. The solution-soaking test phase includes soaking the bottom surface of the specimen in the caustic solution for a predetermined total soak time. The concentration of the caustic compound in the caustic solution and the soak time are selected to simulate a predefined lifetime of washings in an automatic dishwasher.

The concentration of the caustic compound in the caustic solution and the total soak time can be selected by using an innovative methodology. The methodology includes defining the lifetime of use/abuse in terms of a number of automatic dishwasher cycles, deriving a formula for estimating the concentration based on a concentration of the caustic compound in water when used in automatic dishwashers, preparing the caustic solution according to concentration formula, and soaking at least one sample cookware item in the caustic solution for a predetermined test phase soak time. The methodology further includes washing another sample cookware item in an automatic dishwasher a predetermined number of cycles, then visually comparing the cooking surface of the soaked sample to that of the automatic dishwashed sample. Then the soak is repeated until the cooking surface of the soaked sample closely matches that of the automatic dishwashed sample, the number of soaks required to obtain the match is identified. Finally, the total soak time is determined by multiplying the number of soaks by the test phase soak time. In one example, the caustic solution includes water and NaOH, the concentration of the NaOH in the caustic solution is about 0.04%, and the test phase soak time is about 24 hours, and the total soak time is about 120 hours.

In some embodiments, the test method further includes at least one surface-degrading test phase for degrading at least the test area of the bottom surface. For example, the surface-degrading test phase can be a heat-abrasion test phase, a food-baking test phase, or a combination of them. The heat-abrasion test phase includes heating a grate of a cooking device and abrading the test area of the bottom surface on the grate. The food-baking test phase includes heating a cooking-surface staining food item, a food-cooking substance, or both on the test area of the bottom surface. The surface-staining food item used in the food-baking test phase can be, for example, tomato paste, yellow curry, or both. And the food-cooking substance used in the food-baking test phase can be, for example, cooking oil. These test phases can be repeated a predetermined number of times to simulate, in an accelerated time period, a lifetime of cookware use/abuse.

A second example method according to the invention is an accelerated-time test method for evaluating the release performance of the nonstick cooking surface of a cookware test specimen. The method includes at least one surface-degrading test phase that degrades the nonstick cooking surface and a concluding release test phase using a food item that tends to stick to cooking surfaces, for example, an egg. The concluding release test phase can include using a rating scale with more than two ratings and rating the release performance of the nonstick cooking surface more specifically than pass or fail by using the rating scale. In addition, the method can include an initial release test phase using a surface-sticking food item of the same type as used in the concluding release test phase. The initial release test phase should be performed before any surface-degrading test phases.

In some embodiments, the surface-degrading test phase includes a food-baking test phase, a tiger paw test phase, an automatic dishwasher test phase, or a combination of two or three of these. The food-baking test phase includes heating salt and a greasy food item on the nonstick cooking surface. The greasy food item can be, for example, a hamburger patty. The tiger paw test phase includes abrading the nonstick cooking surface with the impact tips of a tiger paw device (or the like). And the automatic dishwasher test phase includes washing the specimen in an automatic dishwasher for at least one cycle. The automatic dishwasher phase is preferably performed immediately before the concluding release test phase, and the food-baking phase and the tiger paw phase are preferably repeated multiple times between the initial and concluding release test phases.

A third example method according to the invention is a sear test method for evaluating the searing performance of the cooking surface of a cookware test specimen. The method includes searing a piece of meat on the cooking surface and evaluating color or darkness against a plurality of standardized fond colors and/or darknesses. The standardized fond colors and/or darknesses have progressively darker color hues, darkness degrees, or both. When using standardized colors, the color hues are matched, and inherently the darkness degrees are also matched. When using standardized darknesses shown in black-and-white shading, only the darkness degrees are matched.

In some embodiments, the method includes evaluating a fond made from the seared meat, evaluating the seared meat piece itself, or both. When evaluating the fond color and/or darkness, the method includes removing the meat piece from the cooking surface while leaving cooked-on meat residue on the cooking surface, mixing a liquid with the meat residue to form a fond, and evaluating the color and/or darkness of the fond against a plurality of standardized fond colors and/or darknesses. As an example, ten standardized fond colors and/or darknesses can be provided on a chart for use in the method. The liquid used to form the fond can be, for example, white wine. When evaluating the sear color and/or darkness, the method includes evaluating the color/darkness of the seared meat against a plurality of standardized sear colors and/or darknesses. As an example, four standardized sear colors and/or darknesses can be provided on a chart for use in the method. Actual photographs of seared meat pieces with progressively darker color hues and/or darkness degrees can be used in the chart.

In another aspect of the invention, there are provided high-performance cookware items that pass one, some, or all of the performance test methods described herein. A cookware item that passes all of the herein-described test methods has a truly exceptional and unusual combination of excellent durability, nonstick, and searing characteristics.

The specific techniques and structures employed to improve over the drawbacks of the prior devices and methods and accomplish the advantages described herein will become apparent from the following detailed description of example embodiments and the appended drawings and claims.

### BRIEF DESCRIPTION OF THE DRAWINGS

The patent or application file contains at least one drawing executed in color. Copies of this patent or patent application publication with color drawings(s) will be provided by the Office upon request and payment of the necessary fee.

FIG. 1 is a flow diagram of an example method for evaluating the durability of an exterior bottom surface of cookware test specimens.

FIG. 2 is a perspective view of a plurality of the cookware test specimens soaking in a container of a caustic solution during a caustic-solution test phase of the method of FIG. 1.

FIG. 3 is a flow diagram of an example method for evaluating the release performance of an interior cooking surface of cookware test specimens.

FIG. 4 is a plan view of one of the cookware test specimens showing a temperature-measuring location during the method of FIG. 3.

FIG. 5 is a perspective view of one of the cookware test specimens during a tiger paw test phase of the method of FIG. 3.

FIG. 6 is a flow diagram of an example method for evaluating the sear performance of an interior cooking surface of cookware test specimens.

FIG. 7 is a perspective view of a food item being pre-measured for use in the method of FIG. 3.

FIG. 8 is a perspective view of the food item being seared in one of the cookware test specimens during the method of FIG. 3.

FIG. 9 is a fond color/darkness chart for use in the method of FIG. 3.

FIG. 10 is a photograph showing a fond's color/darkness being compared to the fond color/darkness chart during the method of FIG. 3.

FIG. 11 is a photograph showing a sear color/darkness chart for use in the method of FIG. 3.

### DETAILED DESCRIPTION OF EXAMPLE EMBODIMENTS

Generally described, the present invention relates to methods for testing the performance of cookware. The methods can be used to test the performance of a variety of types of cookware (e.g., pots, pans, skillets, griddles, dishes, bowls, woks, and/lids therefor) during and/or after a period of simulated cooking (e.g., range-top cooking, grilling, and/or baking) and/or cleaning. The performance tested can be the durability of the exterior bottom surface, the non-stick (i.e., release) performance of the interior cooking surface, the searing performance of the cooking surface, and/or combination of two or three of these.

### Accelerated-Time Test For Durability

A test method according to a first example of the invention is an accelerated lifetime use/abuse test that evaluates the durability of the exterior surface of the cookware article, in particular, the bottom surface. This procedure is used to simulate a lifetime of use/abuse caused by abrasion on the bottom surface of the cookware during cooking and cleaning. This abrasion can be caused by a grate of a cooking device (e.g., a range burner, gas or electric), with an integrated baked-on food element, and coupled with exposure to hand detergents and a simulated automatic dishwasher environment using a concentrated caustic soaking solution. The method is designed to simulate the abuse that the bottom surface of a cookware item might likely encounter over a lifetime from everyday use on common residential or commercial cooking surfaces and in household automatic dishwasher environments.

A “lifetime” for cookware is a very difficult thing to define. In the home-use example described herein, a “lifetime” is considered to be about 3,500 dishwasher cycles. This is based on about 3 to about 4 dish-washings a week, for about 50 weeks a year, for about 20 years. In alternative methods, a lifetime can be considered to be a number of dishwasher cycles between about 3,250 and about 3,750, or between about 3,000 and 4,000. For testing for commercial (restaurant) use, a lifetime can be considered to be a higher or lower number of dishwasher cycles, for example, between about 6,000 and about 8,000, or between about 12,000 and about 14,000. As an example for commercial use, a lifetime can be based on about 7 to about 8 dish-washings a week, for about 52 weeks a year, for about 20 years. This is the basis of the about 6,000 to about 8,000 dishwasher cycle range, and could be appropriate for restaurants that typically wash cookware once a day (e.g., dinner-only restaurants, places with a large number of cookware items of the same type). As another example for commercial use, a lifetime can be based on about 12 to about 13 dish-washings a week, for about 52 weeks a year, for about 20 years. This is the basis of the about 12,000 and about 14,000 dishwasher cycle range, and could be appropriate for restaurants that typically wash cookware more than once a day on average.

Instead of actually subjecting the cookware to 3,500 dishwasher cycles, an innovative approach was devised involving a soak in a caustic solution. The caustic solution can include water and a caustic compound such as sodium hydroxide (NaOH), though alternative or additional caustic compounds such as sodium carbonate (NaHCO3) or others commonly used in dishwasher detergents can be used. NaOH works well in the test method because it is a major component of conventional commercial-strength dishwasher detergents. NaOH is commercially available from Enviro Chemical (Atlantic) Ltd.

A calculation was performed to estimate a workable concentration of the NaOH for simulating a lifetime of use/abuse. Instead of basing the calculation on precisely 3,500 dishwasher cycles, it was decided to use a higher number in the calculation (by a factor of about 2) to err significantly on the abusive side. The calculation was based on 7,200 dishwasher cycles, which was based on 360 cycles per year (about one a day) for 20 years. For a conventional residential-dishwasher detergent, it is generally recommended to use about 20 to about 25 grams for one dishwasher cycle. A conventional commercial-strength dishwasher detergent is about 30% NaOH. Different dishwashers (commercial and residential) use different amounts of water in a complete wash/rinse cycle. (Generally, commercial dishwashers use more aggressive pressure, heat, and detergent strength, but shorter wash and rinse cycle times.) Three dishwashers were evaluated, with the first using about 6 to about 8 gallons per cycle, the second using about 9 to about 12 gallons per cycle, and the third using about 12 to about 20 gallons per cycle. To err on the abusive side, it was decided to base the calculation on 8 gallons (less water means a higher percentage of the caustic compound, and thus a more caustic solution). About half of the water used in a complete dishwasher cycle is mixed with detergent and used in the wash cycle, and the other about half is used in the rinse cycle. Therefore, 4 gallons of water was used in the calculation. In addition, a typical complete dishwasher cycle is about 45 minutes, with the wash cycle being about 15 minutes. Based on all of this, the following calculation was made:

$$( 7 \text{,} 200 DW cycles ) ( 20 \text{g} detergent ) ( 0.3 \% NaOH ) / ( 7 \text{,} 200 DW cycles ) ( 4 gal . H 2 O ) = \frac{43 \text{,} 200 g NaOH}{28 \text{,} 800 gal . H 2 O} = \frac{1.5 g NaOH}{gal . H 2 O}$$

Using this formula, the caustic solution is then made by adding 1.5 g NaOH to each gal. water in the container. This formula works for any predetermined lifetime period selected because the number of cycles is in the numerator and the denominator, and it thus cancels out.

Experimentation was then conducted by soaking pre-test sample cookware items (e.g., hard-anodized and sealed omelet pans) in the caustic solution, and then visually comparing the resulting surface dissolution to that of identical pre-test sample cookware items subjected to a predetermined number of automatic dishwasher cycles (e.g., using CASCADE powdered detergent). This involved subjecting one or more of the sample pans to a predetermined number of dishwasher cycles, subjecting one or more other of the sample pans to a soak in the caustic solution for a test phase soak time (which was selected as 24 hours), comparing the automatic dishwashed sample pans results to the 24-hour-soaked pans, and repeating the soak numerous times until a close visual match was made. The number of soaks required to achieve the close match is noted and multiplied by the number of automatic dishwashing cycles each soak simulated in order to obtain the total soak time required, at the given solution concentration, to simulate the lifetime of use/abuse. The comparison was not exact because it was made visually, it did not account for heat, and some re-anodizing is believed to occur in the process. Nevertheless, this comparison provides a close enough match, given that other variables are erred for on the abusive side. This experimentation resulted in the following conclusion: a soak in an about 0.04% NaOH solution strength (1.5 g NaOh/gal. H2O) for 24 hours equals approximately 700 dishwasher cycles. So to simulate a lifetime of about 3,500 automatic dishwashings, cookware test specimens are subjected to a soak in an about 0.04% NaOH solution strength (1.5 g NaOh/gal. H2O) for about 24 hours, with the soak repeated 4 times (for a total of 5 soaks), resulting in a total soak time of 120 hours. It will be understood that the caustic solution can be made with a higher or lower percentage of NaOH (or another caustic compound) with good results for simulating about 700 dishwasher cycles (or somewhat more or fewer) in an about 24-hour (or somewhat longer or shorter) soak time. For example, the caustic solution can be about 0.03% to about 0.05% NaOH, about 0.02% to about 0.06% NaOH, about 0.02% to about 0.06% NaOH, under about 0.10% NaOH, under about 0.25% NaOH, or under about 0.50% NaOH.

In alternative test methods, by using the methodology described above, the caustic solution can be made with a higher percentage of caustic compound and used with the same soak time for simulating more than 700 dishwasher cycles, used with a longer soak time for simulating more than 700 dishwasher cycles, or used with a shorter soak time for simulating more or less than 700 dishwasher cycles, whether the caustic compound used is NaOH or another caustic compound. Similarly, by using the methodology described above, the caustic solution can be made with a lower percentage of caustic compound and used with the same soak time for simulating less than 700 dishwasher cycles, used with a shorter soak time for simulating less than 700 dishwasher cycles, or used with a longer soak time for simulating more than 700 dishwasher cycles, whether the caustic compound used is NaOH or another caustic compound. Higher concentrations are more caustic so greater care should be taken when using them. Lower concentrations are less caustic and thus generally safer, but the soak time may need to be increased beyond what is acceptable.

To perform the test method of the example described herein, the following equipment/items can be used:
1) a container (e.g., a polypropylene tub) sufficient in size (e.g., a 5-gal. pail or 3-gal. tote) to hold the caustic solution and the desired number of test specimens, and a rack (e.g., plastic coated wire, nylon zip ties, or wire rack) to suspend/hold the test specimens in the container;
2) water;
3) a caustic compound (e.g., NaOH crystals);
4) a weight-measuring device (e.g., an electronic balance scale capable of measurement to 0.1 oz. or 0.1 g), not needed if the NaOH or other caustic compound is provided in pre-measured form, e.g., beads, capsules, or tablets;
5) a cooking device (e.g., a range, residential- or commercial-type, gas or electric) with a grate (e.g., a non-enameled burner grate or a worn enameled grate);
6) a scrub pad (e.g., a nylon DOBIE scrub pad);
7) liquid dishwasher detergent (e.g., DAWN dishwasher detergent);
8) food items (e.g., tomato paste, yellow curry paste i.e. curry and water, and/or cooking oil); and
9) safety equipment/items including safety goggles or a face shield, neoprene gloves, hazardous material and warning signs, adequate ventilation, access to water (e.g., 60° to 70° F./16° to 21° C. running tap water), and a first aid kit.

Before performing the test method, the following safety considerations are advised to be taken into account.
1) The 0.04% NaOH solution strength creates a pH of about 11 to about 12. While this solution strength is very weak, the high pH requires that caution be exercised to prevent spills and personal exposure to the caustic chemical.
2) NaOH should be added slowly to cool water to prevent the exothermic character of the crystals from over-heating the water.
3) Neoprene gloves and eye protection should be worn when handling the caustic solution and the soaked cookware test specimens.
4) The container of caustic solution should be located in a low-traffic area, with warning and hazard signs clearly posted.
5) The crystalline nature of NaOH makes breathing corrosive dust unlikely, however, it is important to handle the crystals carefully and to keep the container of crystals tightly closed except when dispensing the NaOH into the water to mix the caustic solution. The container of NaOH crystals should not be left open any longer that it takes to measure out the amount needed for making the caustic solution.
6) Test personnel are advised to familiarize themselves with the NaOH MSDS information.

Before performing the test method, the test personnel are advised to familiarize themselves with the following first aid procedures.
1) Inhalation: Leave the exposure area immediately and go to an area of fresh air.
2) Skin Contact: Remove contaminated clothing immediately. Wash the affected skin area with soap or mild detergent using large amounts of water for an extended period of time (e.g., 15 to 20 minutes).
3) Eye Contact: Wash the eyes immediately with large amounts of water, occasionally lifting the upper and lower lids, for an extended period of time (e.g., 15 to 20 minutes) until no evidence of the chemical remains. Continue irrigating the eyes with normal saline solution for an extended period of time (e.g., an additional 30 to 60 minutes). Cover the eyes with sterile gauze bandages and seek immediate medical attention.
4) Ingestion: Drink large quantities of water and seek immediate medical attention.
   These first aid procedures are general recommendations and do not constitute medical advise—when in doubt immediate medical attention should be sought.

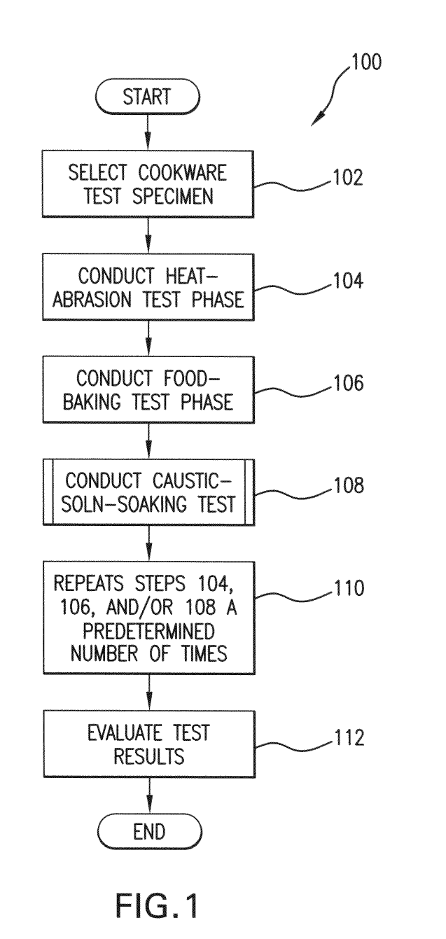

Having addressed certain pre-testing considerations, details of the test method 100 will now be described with reference to FIG. 1. At step 102 a test specimen of cookware is selected (e.g., a 10-inch fry pan or a production item from a lot of cookware to be tested), and a handle (e.g., a long handle) is attached to it (if the cookware item does not already have a handle sufficiently long for tester safety). Then the test specimen is placed on a grate of a cooking device (e.g., a burner of a typical residential range), and the specimen is heated until a predetermined interior cooking surface temperature (e.g., 400° F.) is stabilized.

Next, at step 104 the bottom surface of the cookware test specimen is subjected to a predetermined number (e.g., 1,000) of abrasion cycles on the hot grate. In particular, the specimen is slid over the hot burner grate with no downward pressure; only the weight of the specimen creates the abrasion force. Alternatively, a predetermined amount of downward pressure can be applied (e.g., by a machine, by a weight in the cookware, etc.), as long as it is done consistently. One cycle can be defined as sliding the specimen over the grate back and forth once (e.g., forward once and backward once, or left and right once) or sliding the specimen over the grate in a complete 360° circle. This step can be done manually (by a person) or automatically (by a machine).

At step 106, after completing the predetermined number of heat-abrasion cycles, a food-baking phase is performed. The cookware test specimen is turned over so that the hot bottom surface is facing up. Then a predetermined amount (e.g., about the size of a half-dollar, about half an ounce) of at least one food item is placed onto the hot bottom surface.

The food item is selected for its tendency to stain cookware and/or for its common usage in cooking. For example, a surface-staining food item can be tomato paste (e.g., any tomato-based substance such as ketchup or barbeque sauce), curry paste, mustard, coffee, red wine, and/or a combination thereof, and a common food-cooking substance can be a cooking lubricant such as cooking oil (e.g., canola oil, olive oil, another vegetable oil), lard, butter, margarine, and/or grease, a seasoning such as salt, pepper, and/or herbs, and/or a combination thereof. Using tomato paste, curry, and cooking oil together works well because tomato paste is an aggressive-staining acidic food, curry paste is a moderate-staining base food, and cooking oil is one of the most common (if not the most common) food item generally used in cooking. So adding the predetermined amount of each to the bottom surface of the test specimen will provide a good indication of the durability of the bottom surface. Alternatively, only two food items may be used, for example, an aggressive-staining food and a commonly-used cooking substance. Of course, alternative and/or additional food items can be used. The food item can be a humanly edible substance, a simulant thereof, or another substance that when heated in cookware simulates common cooking use/abuse and/or stains the cookware.

Since the test area of the bottom surface containing the food items will need to be submerged in the caustic solution, the test area may be located off-center, for example opposite from the handle and near the sidewall of the specimen. An indelible pen may be used to mark the test areas where the food items are to be placed in order to ensure that all of the food-item placements can be made at the same locations (e.g., so that tomato paste is applied to the same area in each test cycle). In addition, the food-baked test areas of the bottom surface should be locations that were subjected to the abrasion forces during the heat-abrasion test phase.

When the cookware test specimen has cooled to near ambient temperature, the food items may be washed from the bottom surface. This can be done, for example, using a scrub pad, a mild dishwashing detergent, and warm water.

It should be noted that the test method 100 can include only one of these surface-degrading test phases, it can include one or both of these and also additional surface-degrading test phases (described herein or not), it can include only one or more other surface-degrading test phases, or it can include no surface-degrading test phases. In the last case, the focus of the test method is on the innovative caustic-solution test phase, which is described next.

Next, at step 108, the cleaned cookware specimens are suspended/held and soaked in a caustic solution in a container. A caustic solution is created, for example, a 0.04% (by weight) solution of NaOH (a.k.a. caustic soda or lye) and water in a container. For safety, a tip-resistant, spill-resistant, polyethylene container may be used. Table 1 provides suggested quantities of the NaOH and water to obtain the 0.04% solution strength.

TABLE 1

| Container Size | (NaOH) | Water |
|---|---|---|
| 5 gal. pail | 7.5 g | 5 gal. (18.94 kg) |
| 2.5 gal. tote | 3.0 g | 2 gal. (7.58 kg) |
| 1.5 gal. container | 1.5 g | 1 gal. (3.78 kg) |

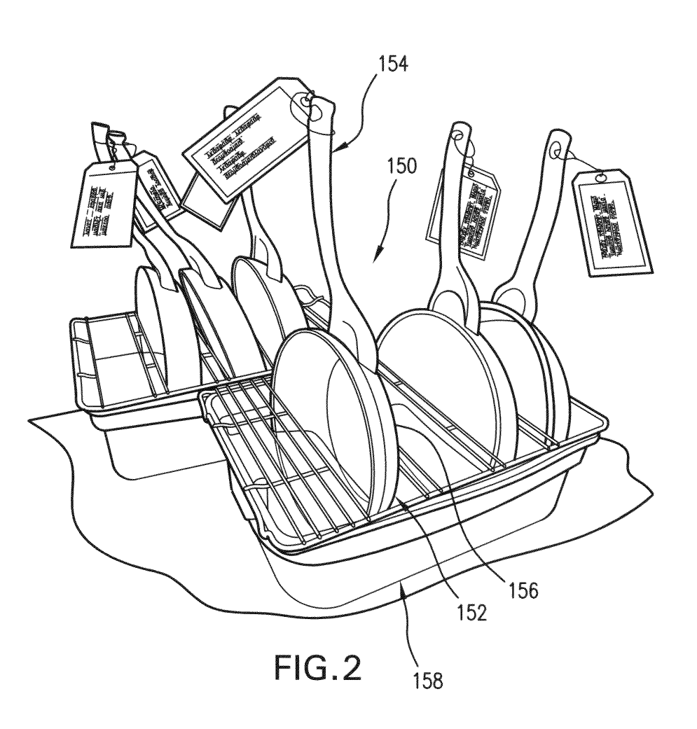

The food-baked areas of the heat-abraded bottom surface need to be exposed to the solution, and the areas to be exposed to the caustic solution should be the same for each successive soak. A good way to ensure that the proper areas are soaked is to always place the specimens in the container with the handles oriented in the same direction. For example, as shown in FIG. 2, if the food items are placed on the bottom surface 156 of the cooking vessel 152 of the specimen 150 off-center and opposite the handle 154, then the specimens could be placed in the container 158 with the handles oriented generally straight upward.

The cookware test specimens are left soaking in the caustic solution in the container for a predetermined amount of time. For example, the soak time can be 24 hours, which for a 0.04% NaOH solution approximates 700 dishwasher cycles (as discussed above). Alternatively, a higher concentration of the same or another caustic compound can be used with a shorter soak time, or a lower concentration and longer soak time can be used. Also, the concentration and soak time can be selected to be different for residential versus commercial simulations.

At the end of the soak time, the cookware test specimens are removed from the container. The food-baked areas may be washed again, for example by lightly scrubbing using a hand dish detergent, warm water, and a soft scrub sponge. Then the test specimens are rinsed (e.g., with clean water) and dried (e.g., with a soft cloth towel).

This completes one test cycle. At the completion of each test cycle, the effect of the test cycle (the current condition of the bottom surface) is evaluated. The results may be recorded (e.g., by a photograph of the surface or by written notes) and reported by test personnel. Alternatively, the bottom surface can be evaluated after each individual test phase or after only certain of them.

Each test cycle includes the heat-abrasion, food-baking, and solution-soaking phases. The test cycle can then be repeated a predetermined number of times. For example, in the described example the test is intended to simulate at least 3,500 dishwasher cycles with a significant margin for error, so the soaking test phase includes a 24-hour soak in a 0.04% NaOH solution (which simulates 700 dishwasher cycles), so the test cycle is repeated five times to simulate, in an accelerated time period, a lifetime of use/abuse. Alternatively, one or more of the heat-abrasion, food-baking, and/or solution-soaking test phases can be eliminated in a given test cycle, and/or additional test phases can be included in the test cycle. If a different soak time and/or solution strength is used, then the test cycle may need to be repeated more or fewer than five (maybe even zero) times. In an alternative embodiment, the caustic-solution-soak test phase can be used by itself, or in combination with other cookware performance test phases (described herein or not), to test the durability of the bottom surface of the specimen.

After the predetermined number of test cycles have been completed, the test is concluded. At the conclusion of the test, at step 112 the cumulative effects on the cookware test specimen are evaluated. The test specimen is rated as “pass” if there are no visual defects on the bottom surface of the specimen (i.e., on the paint or other coating or surface treatment). The test specimen is rated as “fail” if there is a visually-detectable change in color, gloss, or adhesion, if there is visually-detectable substrate exposure, pitting, bubbling, or substrate attack, or if there are other predefined objectionable characteristics (e.g., visually-detectable or measured by a machine, etc.) such as reduced coating thickness, increased adhesion characteristics, or reduced abrasion resistance. Of course, other specific pass/fail criteria can be selected of ruse in the test method.

### Accelerated-Time Test For Release Performance

A test method according to a second example of the invention is an accelerated in-home use/abuse test that evaluates the release performance of a cooking surface (e.g., a non-stick or other coating or treatment) of cookware. This procedure is used to evaluate the release performance of cookware (e.g., range-top cookware) in an accelerated in-home cooking environment using food items and exposure to an automatic dishwasher environment.

In alternatives methods, this test can be adapted for use simulating, on an accelerated basis, a commercial cooking environment. However, many restaurants are not particularly concerned about the appearance of their cookware, so they use very high heat, which can reasonably be considered misuse and which can prematurely diminish the release performance of cookware over time.

To perform the example in-home test method of the example described herein, the following equipment can be used:
1) a cooking device (e.g., a range, residential- or commercial-type, gas or electric);
2) a temperature-measuring device (e.g., a contact pyrometer or an infra-red thermometer calibrated to a contact pyrometer);
3) a tiger paw device (e.g., hand-held three-pen type);
4) a timer;
5) a diffuser (if a gas range is used);
6) kitchen utensils (e.g., spatulas, spoons, and measuring spoons and cups);
7) food items (e.g., eggs and hamburgers);
8) an automatic dishwasher (e.g., continuous-cycle type); and
9) an adjustable angle plate with a pitch/angle locator.

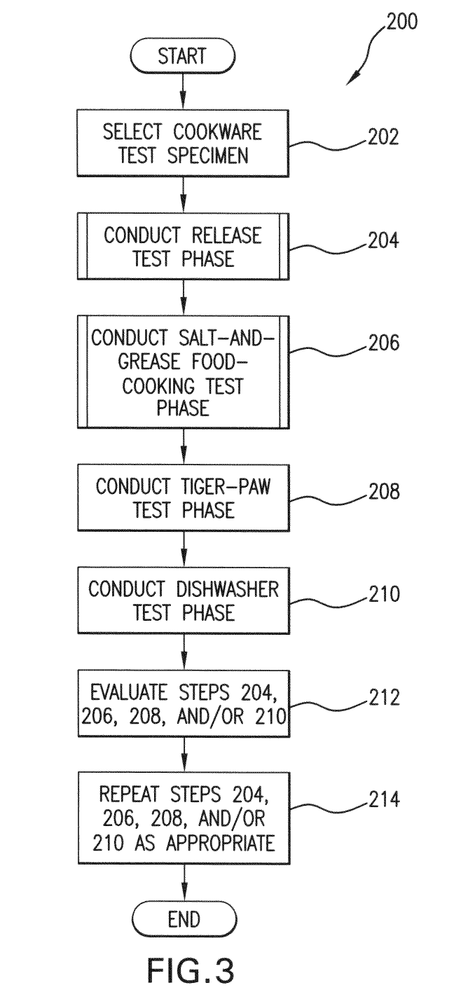

With reference to FIG. 3, to begin the test method 200, at step 202 a test specimen of cookware is selected (e.g., a 10-inch fry pan or a production item from a lot of cookware to be tested). The specimen can be tested at about room temperature (70° F.+/−10° F.). Before testing, the specimen may be hand-washed with warm tap water and a mild dishwashing detergent, rinsed several times in hot tap water, and blotted dry with a paper towel.

The test method includes a first release-performance phase using a food item that tends to stick to cooking surfaces, for example an egg. This test phase is used to determine the ability of the non-stick cooking surface of the cookware test specimen to release surface-sticking food that is cooked on it. The food item can be a humanly edible substance, a simulant thereof, or another substance that when heated in cookware simulates cooking use/abuse, as long as it tends to stick to cooking surfaces when heated to common cooking temperatures. Alternatively, a food item other than an egg may be used for this test phase, with the food item selected for testing the release performance.

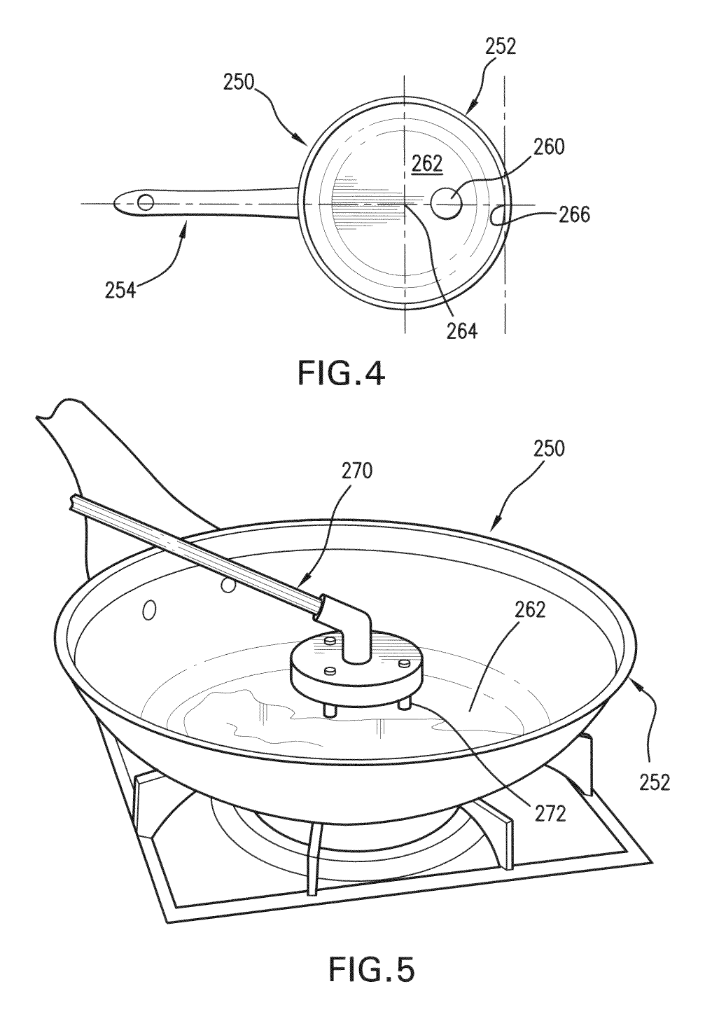

A cooking device (e.g., a range burner) is turned on (e.g., to mid-heat) and the cookware test specimen is placed on the cooking device (e.g., the center of the burner) until a predetermined pre-heat temperature range is stabilized. For example, the pre-heat temperature range can be about 375° to about 400° F. (about 188° C. to about 204° C.), as measured by a temperature-measuring device such as a contact pyrometer or infrared thermometer, and which can generally be attained in about 3 to about 5 minutes. The temperature should be measured consistently at the same location, for example, at a place 260 on the cooking surface 262 about midway between the center 264 and the sidewall 266 of the cooking vessel 252 of the specimen 250, opposite the handle 258, as shown in FIG. 4. Alternatively, the temperature can be measured at another location, for example at the center, or closer to the center than the sidewall, as long as this is done consistently. For consistent and reliable results, the temperature of the specimen should not be allowed to fall below the minimum of the temperature range during the heat-up periods prior to testing and during testing.

Next, a food item that tends to stick to non-stick cooking surfaces (e.g., one cold, fresh egg) is placed into the cookware test specimen (e.g., in the center) for a first cooking stage of the test phase. When using an egg, it is first cracked and its contents are placed into the test specimen. No cooking lubricant (e.g., butter, cooking oil) should be used, as the purpose of the test phase is to evaluate the non-stick performance of the cooking surface. The specimen should not be tipped or swirled, because this may cause the egg to run. The egg is then cooked undisturbed for a first predetermined cooking time, for example, 3 minutes. After a predetermined portion of the cooking time, for example 2 minutes, the temperature of the specimen can be checked using the temperature-measuring device. The temperature may be allowed to rise to higher than the pre-heat temperature range, for example, to a predetermined cooking temperature range of about 380° F. to about 420° F. (about 193° C. to about 216° C.). If the temperature rises to outside of the cooking temperature range, the burner should be adjusted to decrease the heat.

At the end of the cooking period, the cookware test specimen is removed from the cooking device (e.g., the burner) and tilted to see if the egg slides freely. If the egg does not slide, it should be gently lifted with a cooking utensil (e.g., a spatula). The egg is completely removed from the cooking surface, and the test personnel may note and record the release of the egg from the specimen (i.e., the effort required to free the egg from the cooking surface of the specimen) using a predetermined rating scale (e.g., using Table 2 below) or a pass/fail rating.

Next, the cookware test specimen is returned to the cooking device (e.g., the burner) for a second cooking stage of the test phase. The egg is turned over and the yolk can be optionally broken (e.g., with the spatula). The egg is cook undisturbed for a second predetermined cooking time, for example, 2 minutes. At the end of this time, the egg is removed from the specimen as previously done, and the test personnel may note and record the release of the egg from the specimen using a predetermined rating scale (e.g., using Table 2 below) and/or a pass/fail rating. In addition, the test personnel may make note of any staining and the amount of any residual egg material adhering to the specimen. Alternatively, the second cooking stage can be eliminated and the test phase can be based on only the first cooking stage, or the food item can be returned to the specimen for any desired subsequent cooking stages.

In a pass/fail rating, if the egg lifts easily from the cooking surface with no sticking around the edges of the egg, this is an excellent release and the test specimen is rated as “pass.” If not, then this is a poor release and the test specimen is rated as “fail.” Of course, other specific pass/fail criteria can be selected for use in the test method. If the specimen fails, then the remaining test phases need not be performed. Alternatively, other pass/fail standards (e.g., failure as a predetermined volume or area of the egg sticking to the cooking surface) can be used.

In an innovative new rating system, a predetermined scale is used to more accurately rate the release performance. An example is shown in Table 2, which is specific to eggs but can be readily adapted (as would be understood by persons of ordinary skill in the art) for other food items that tend to stick to cooking surfaces of cookware.

TABLE 2

| Rating | Effort to free the egg from the cooking surface |
|---|---|
| 10 | Egg slides when pan is tilted |
| 9 | Slight nudge with spatula and egg slides |
| 8 | Egg has slight/weak grip, spatula assist necessary |
| 7 | Egg has medium-strong grip, spatula assist necessary |
| 6 | Egg has strong hold (suction), spatula necessary |
| 5 | Egg residue sticks (around edges) 10-20%, spatula assist |
| | necessary |
| 4 | Egg residue sticks 40%, spatula assist necessary |
| 3 | Egg residue sticks 60%, spatula assist necessary |
| 2 | Egg residue sticks 80%, spatula assist necessary |
| 1 | Egg residue sticks >80%, heavy residue remains, spatula assist |
| | necessary |

Thus, if the egg sticks and a spatula is needed to release it from the cooking surface, and if when the egg is removed using the spatula about 40% of the egg remains on the cooking surface, then the specimen would be rated as “4.” In alternative examples of the invention, a different rating scale is used, for example, with more or fewer discrete rating levels (e.g., from 1 to 5, or from 1 to 20). And in other alternative examples, this innovative rating scale can be used in cookware release-performance test methods that include only this test phase (using eggs or another surface-sticking food item) without any surface-degrading test phases, or that include other cookware surface-degrading test phases (described herein or not) that simulate cookware use/abuse by degrading the nonstick cooking surface.

The test method 200 at step 206 includes a salt-and-grease food-cooking phase such as a salted hamburger test. This test phase is used to determine the effects of salt and grease on the cooking surface. Salt and grease (or simulants thereof) are used in the example test described herein because they are commonly used in home cooking and they tend to break down many common non-stick coatings on cookware. Alternatively, one or more different food items may be used for this test phase, with the food item selected for testing the effects of salt and grease on the nonstick cooking surface.

The cookware test specimen is replaced on the cooking device (e.g., on a burner of a range on mid-heat) until the same or a predetermined different cooking temperature range is stabilized. For example, the same cooking temperature range of about 380° F. to about 420° F. (about 193° C. to about 216° C.) may be used. A predetermined amount (e.g., one tablespoon) of cooking lubricant (e.g., corn oil) is measured and placed into the test specimen (e.g., in its center). A generally greasy food item (e.g., a hamburger patty) of a predetermined sized (e.g., about ¼ lb.) is seasoned with salt (e.g., ⅜ teaspoon on each side), placed in the specimen (e.g., in its center), and cooked (e.g., fried) for a predetermined total cooking time, for example 8 minutes. As one example, the hamburger patty may be fried on one side for a first-stage cooking time, for example 3 minutes, flipped and fried on its other side for a second-stage cooking time, for example an additional 3 minutes, and then flipped back over to its first side and fried for a third-stage cooking time, for example 2 more minutes. As another example, the hamburger patty can be salted and fried on only one side for a single-stage cooking time, for example 4 minutes. The hamburger patty may be fried with a cover on the test specimen during only some or all of the stages, and more or fewer stages may be used, as long as this is done consistently for every specimen tested.

In this example, the salted hamburger patty is cooked to test for salt and grease in a single step. Alternatively, a different salted greasy food item such as sausage can be used. In other alternatives, a generally non-greasy food item (e.g., chicken or vegetables) can be salted and cooked in one step to test with salt and a greasy food item (e.g., hamburger or sausage) can be cooked unsalted in a separate step to test with grease, though using a salted greasy food item is generally preferable.

After the cooking time is up, the cookware test specimen is removed from the cooking device. Optionally, the hamburger patty can be divided into portions (e.g., quarters) while still in the specimen using a non-serrated metal kitchen implement such as the edge of a spoon or a fork, as long as this is done consistently for each specimen tested. This can be done to further simulate normal in-home use. The hamburger patty is removed from the test specimen, which can then be wiped clean (e.g., with a paper towel).

Finally, the effects of this test phase are evaluated and recorded. If there is any visually-detectable blistering, bubbling, pitting, staining, or discoloration of the non-stick coating, or any other predefined objectionable characteristic (e.g., color fading, delamination, or coating detachment), then the specimen is rated as “fail.” If none of these are visually detectable, then the specimen is rated as “pass.” If the specimen fails, then the remaining test cycles need not be performed. Of course, other specific pass/fail criteria can be selected for use in the test method

The test method 200 also includes at step 208 a tiger paw test phase. The purpose of this test phase is to increase the amount of abuse to which the cookware test specimen is subjected during a cooking test, and to thereby evaluate the damage-resistance of the cooking surface.

Before starting this test, the person conducting the test should test the three ballpoint pen refills (or other cooking-surface-impacting elements) of the tiger paw tester, for example by writing on a piece of paper using firm pressure. All three pen points should write if the tiger paw tester is functioning properly. If any pen point does not write, it should be replaced before proceeding. Due to the severity of the tiger paw test, failures will occur much earlier on finishes of lesser durability. Whenever a question arises concerning the specimen under test, the procedure may be stopped and clarification obtained from the specimen submitter.

A cooking device (e.g., a range burner) is turned on (e.g., to mid-heat) and the cookware test specimen is placed on the cooking device (e.g., at the center of the burner) until a predetermined temperature range is stabilized. For example, the temperature range may be about 375° F. to about 420° F. (about 188° C. to about 216° C.), as measured by a temperature-measuring device such as a contact pyrometer or infrared thermometer.

Then a predetermined amount of one or more food items is poured/placed into the cookware test specimen. The food item is selected to be a food item commonly used in cooking and that is acidic, for example, two cups of tomato sauce. The food item can be a humanly edible substance, a simulant thereof, or another substance that when heated in cookware simulates cooking use/abuse. The food item is cooked for a predetermined amount of time, for example, it can be brought to a boil and then simmered for twenty minutes.

During this cooking time, the tiger paw device 270 is placed onto the cooking surface 262 of the cooking vessel 252 of the cookware specimen 250 and moved in a manner (e.g., circular) that allows all impacting points (e.g., three ink-pen tips) 272 to contact the cooking surface at all times, as shown in FIG. 5. The impacting points are in the area where the food item is placed, so this stirs the food item. No downward pressure should be applied to the tiger paw device, for consistency. Instead, the weight of the free-floating tiger paw head should be the only downward force. Alternatively, a downward pressure can be applied (e.g., by a weight), as long as it is consistently applied to all specimens tested. The cooking food item is stirred with the tiger paw device a predetermined number of times, for example 50 clockwise rotations and 50 counter-clockwise rotations for a total of 100 cycles. After the cooking time is up and the tiger paw rotations complete, the test specimen is removed from the cooking device, emptied, washed (e.g., with dishwashing detergent and warm water), and dried (e.g., with a paper towel). Alternatively, other tiger paw devices can be used, such as those with more or fewer than three impacting tips and/or those with the impacting tips provided by other writing or marking tips or other tips that degrade the cooking surface. Such alternative devices can be machines that impart similar forces and effects as conventional manual tiger paw devices.

Finally, the effects of this test are evaluated and recorded. If there is a visually-detectable 360° exposure (i.e., the arc of a complete circle) of the substrate (below the non-stick coating of the cooking surface) in the path of the impact points of the tiger paw, then the specimen is rated as “fail.” If not (no substrate exposure or some but less than a complete 360° exposure), then the specimen is rated as “pass.” Alternatively, other pass/fail standards (e.g., failure as a certain amount of exposure less than a complete 360° circle) can be used. If the specimen fails, then the remaining test cycles need not be performed.

This completes the first cycle of the accelerated in-home abuse test 200. The test method 200 can next include repeating this cycle a predetermined number of times, for example, three more times (four total). The dry egg test was performed as the initial phase of the first cycle to determine the initial release performance of the specimen, and this phase need not be repeated in every cycle. So the intermediate cycles (e.g., two through four) can include just the hamburger and/or tiger paw test phases (and/or other test phases that simulate cookware use/abuse by degrading the nonstick cooking surface) in order to further degrade the nonstick cooking surface before repeating the dry egg test phase. Alternatively, only one cycle can be done, different ones of the test phases described herein can be done in each test cycle, additional test phases can be included in some or all of the test cycles, and/or some of the herein-described test phases can be eliminated in certain of the test cycles.

The last test cycle, and/or earlier ones if desired, can include an automatic dishwasher exposure test at step 210 to further simulate cookware use/abuse by further degrading the nonstick cooking surface. Alternatively, the caustic-solution-soaking test described herein (or a suitably adapted variation thereof) can be substituted for this test phase. To perform the automatic dishwasher exposure test, the cookware test specimen is placed in an automatic dishwasher, which is then turned on according to its operating instructions. The test specimen is washed in the dishwasher a predetermined number of washing/rinsing cycles, for example ten times. If a continuous-cycle dishwasher is used, it can be set to cycle ten times. At the end of the last cycle, the specimen is removed from the dishwasher and evaluated.

At step 212 (or wherever else desired in the method 200), if there is any visually-detectable blistering, bubbling, detachment, pitting, staining, or discoloration of the non-stick coating, or any other predefined objectionable characteristic (e.g., color fading or delamination), then the specimen is rated as “fail.” If none of these are visually detectable, then the specimen is rated as “pass.” Of course, other specific pass/fail criteria can be selected for use in the test method. If the specimen fails, then the test can be concluded at that point. Thus, if the specimen fails before a final dry egg test phase, the test can be concluded upon such failure. This evaluation can be done after each individual test phase, at the conclusion of each test cycle (including multiple test phases), at the conclusion of the entire test (after multiple test cycles), and/or at only one or some of these times.

The last test cycle can conclude by repeating the dry egg test described above. After having been subjected to one or more of the hamburger, tiger paw, automatic dishwasher, and/or other surface-degrading test phases, the release performance of the non-stick coating of the cooking surface may be diminished from that of the initial dry egg test. Thus, the last test cycle preferably concludes with a repeat of the initial release test phase using the same surface-sticking food item used in the initial release test phase (e.g., an egg) to evaluate the release performance after the surface-degrading test phases.

Then at step 214 the entire procedure (or portions thereof) just described (e.g., all five cycles) is repeated until the total predetermined number of cycles specified for the performance level is achieved. Thus, the accelerated in-home abuse test can be concluded with the dry egg release test, unless earlier full substrate exposure is achieved or if the coating blisters, detaches, pits, etc. (i.e., if the specimen fails an earlier test phase).

The results of the dry egg test, the hamburger test, the tiger paw test, and the dishwasher test can be evaluated and reported after each individual test phase. If a failure occurs, the cycle number when the failure occurred can be recorded.

Accordingly, the sequence of the test phases in the described example method can be:

cycle 1, phase 1: dry egg release;

cycle 1, phase 2: hamburger fry (with salt);

cycle 1, phase 3: tiger paw (with tomato sauce simmer);

cycle 2, phase 1: hamburger fry (with salt);

cycle 2, phase 2: tiger paw (with tomato sauce simmer);

cycle 3, phase 1: hamburger fry (with salt);

cycle 3, phase 2: tiger paw (with tomato sauce simmer);

cycle 4, phase 1: hamburger fry (with salt);

cycle 4, phase 2: tiger paw (with tomato sauce simmer);

cycle 5, phase 1: dishwasher exposure (10 cycles);

cycle 5, phase 2: dry egg release;

cycles 6-10: repeat cycles 1-5; and

continue repeating cycles 1-5 a predetermined number of times or until failure.

If there is a question as to whether there is true substrate exposure, a verification test may be performed. On those occasions when the substrate to be considered is anodized aluminum (as opposed to bare aluminum), the anodized color can be such that it is difficult to be certain that the coating (often similar in color) is completely degraded. This simple verification test can be useful when visual methods and coating thickness instruments cannot confirm substrate exposure. To perform this test, a mixture of distilled water (e.g., about 185 grams) and sodium hydroxide crystals (e.g., about 8 grams) is made. This creates a solution of about 13.8 pH. Using a pipette or dropper, an amount (e.g., approximately the size of a dime) of the solution is dropped onto the suspected area of the cooking surface. If there is a true substrate failure, then the solution will bubble. Bubbling will occur almost immediately if bare aluminum exists, in about 30 seconds to about 45 seconds on anodized aluminum with nickel acetate seal, and in about 3.5 minutes on infused-anodized aluminum.

### Test For Searing Performance

A test method according to a third example of the invention is a searing test. This procedure is used to evaluate the searing performance of an interior cooking surface of cookware using a comparative attribute standard color chart. As used herein, the term “searing” is meant to indicate the amount of “browning” (i.e., darkening) of a piece of meat or other food item being cooked.

To perform the test method of the example described herein, the following equipment can be used:
1) a cooking device (e.g., a kitchen range, residential- or commercial-type, gas or electric);
2) a timer;
3) a fond-creating liquid (e.g., Chardonnay or another white wine);
4) a weight-measuring device (e.g., a metal scale);
5) a temperature-measuring device (e.g., a digital electronic thermometer with a “K-type” surface contact thermocouple probe or an infrared thermal gun with a temperature-averaging feature);
6) a standardized fond chart graduated into multiple visually distinguishable fond color hues and/or darkness degrees; and
7) a standardized sear chart graduated into multiple visually distinguishable sear color hues and/or darkness degrees (e.g., with actual photographs of seared meat).

Before performing the test method, the following safety considerations are advised to be taken into account.
1) Caution should be exercised around high-temperature appliances.
2) Oven mitts or pot holders should be used when handling hot utensils. Also, wearing a kitchen apron is recommended.

The sear test includes a test-preparation step. This step involves the following:
1) A food item is selected and prepared for use in the test. In the test described herein, chicken is used. In alternative examples, the food item used is pork (e.g., a lean pork patty), beef (e.g., steak), fish/seafood, another type of poultry (e.g., turkey or duck), or another type of meat. The meat selected is preferably a select cut with no bone, gristle, void areas, skin, or spoilage. For consistency in test results, one type of meat should be used for all the test specimens, and the selected meat should have the same (or extremely similar) size, weight, and texture in each test. In this example, boneless skinless chicken breasts are prepared into predetermined portion sizes (e.g., about ⅜ inch thick by about 2½ inches wide by about 4 inches long). The meat can be filleted and/or pounded to the specified thickness. To consistently achieve the specified width and length, a cutting template and/or a cutting board/butcher block with inscribed lines may be used. In the example predetermined size of this embodiment, the chicken portions 380 each weigh about 75 grams as measured by a weighing device 382, as shown in FIG. 7. The chicken portions are preferably at room temperature before being placed into the cookware test specimen.
2) An appropriately sized cooking device (e.g., a gas range burner) should be selected for the specimen size to be tested. For consistency, the same size burner (e.g., a 10-inch burner) of the same range (or range type) should be used for all specimens (e.g., 10-inch pans) tested.
3) The temperature-measuring device should be calibrated before measuring the temperatures of the cooking surface and the chicken portions.

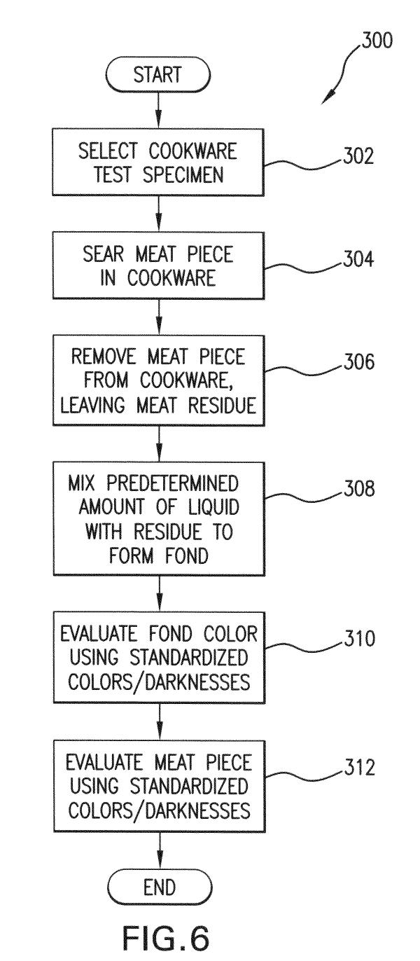

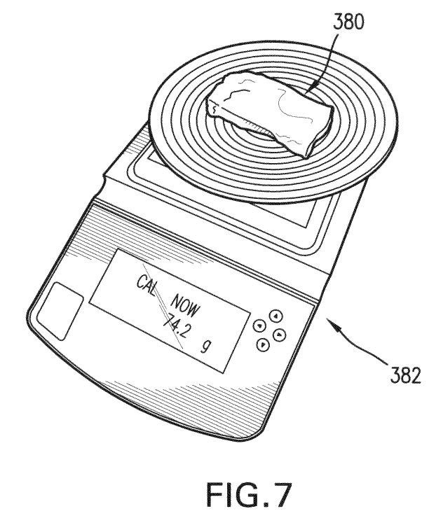

Referring to FIG. 6, to begin the test method, at step 302 a test specimen of cookware is selected (e.g., a 10-inch fry pan or another production item from a lot of cookware to be tested). The specimen may be gently hand washed and carefully dried prior to beginning the test.

A cooking device (e.g., a burner of a gas range) is turned on (e.g., to mid-heat) and the cookware test specimen is placed on the cooking device (e.g., on the center of the burner) until a predetermined temperature or temperature range is stabilized. For example, the predetermined temperature range can be about 400° F. to about 475° F., or the predetermined temperature can be about 450° F. or another temperature between about 400° F. and about 475° F., as measured by a temperature-measuring device. Below about 400° F. the test takes an unnecessarily long time to complete, and above about 475° F. the chicken generally does not cook properly (the outside will burn and the inside will not be cooked). Other temperatures or temperature ranges can be selected for use with for other types of meat, depending on the cooking characteristics of the particular meat being used.

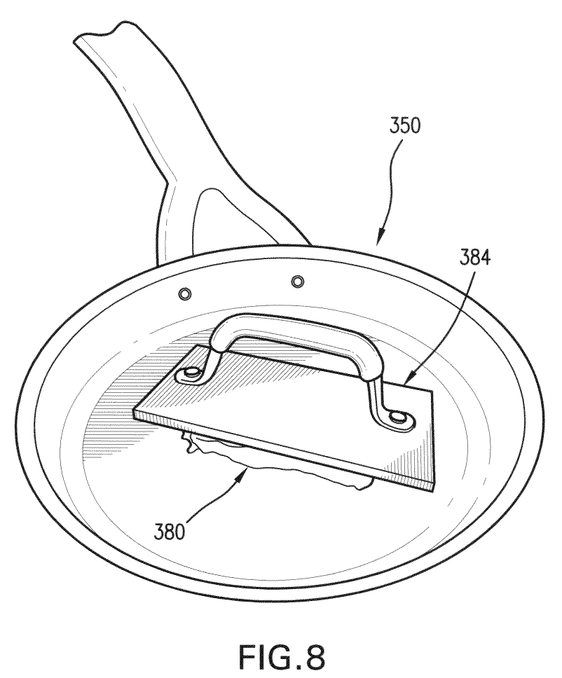

At step 304, a piece of meat (e.g., a chicken breast portion), preferably at about room temperature (about 68° F. to about 74° F.), is placed onto the cooking surface (e.g., at about its center) of the pre-heated cookware test specimen. To prevent heat curling, a flat weight 384 (e.g., about 6.4 oz.±0.2 oz.) can be optionally placed on the chicken portion 380 in the test specimen 350, as long as this is done consistently for every specimen tested (see FIG. 8). The weight standardizes the test, as the meat pieces used in the test tend to vary in shape, even after preparing them into the specified size. In alternative embodiments, the test is conducted without using a weight on the meat pieces.

The timer is turned on and the chicken breast portion is seared for a predetermined cooking time (e.g., 10 minutes). For example, the chicken breast portion may be seared for a first cooking time stage (e.g., 5 minutes), the weight removed, the chicken breast portion flipped over, the weight replaced, and the chicken breast portion seared for a second cooking time stage (e.g., another 5 minutes).

At step 306, after the predetermined cooking time, the weight is removed from the chicken breast portion, which is then removed from the test specimen. The chicken breast portion is set aside (e.g., on a dinner plate). There will be some cooked-on (e.g., carmelized) chicken residue remaining on the cooking surface of the specimen.

At step 308, a predetermined amount (e.g., 59 mL from a graduated cylinder) of a fond-creating liquid (e.g., Chardonnay, another white wine, or another liquid that is generally clear so as not to unduly influence the fond color) is poured into the cookware test specimen. More liquid can be used for larger chicken portion sizes and less for smaller portion sizes. When the wine is poured into the test specimen, a “plume” of rapidly evaporating alcohol is created. The chicken residue on the specimen's cooking surface is then scraped (e.g., with a nylon spatula for non-stick surfaces or a stainless steel spatula for all other surfaces) and mixed with the wine for a predetermined amount of time (e.g., 30 seconds) to create a “fond.”

At step 310, the fond is then evaluated for its color and/or darkness. The caramelization causes a color shift in the white wine. The darker the fond color, the better—darker fonds are generally richer and tastier. The fond may be observed in the test specimen itself or it can removed from the specimen (e.g., emptied into a clear test tube with a stopper or poured onto a plate). The color and/or darkness of the fond is evaluated by comparing it to standardized fond colors or darknesses, for example on a chart (e.g., a conventional chart, table, or other printed material), that are graduated into multiple progressively darker color hues and/or darkness degrees.

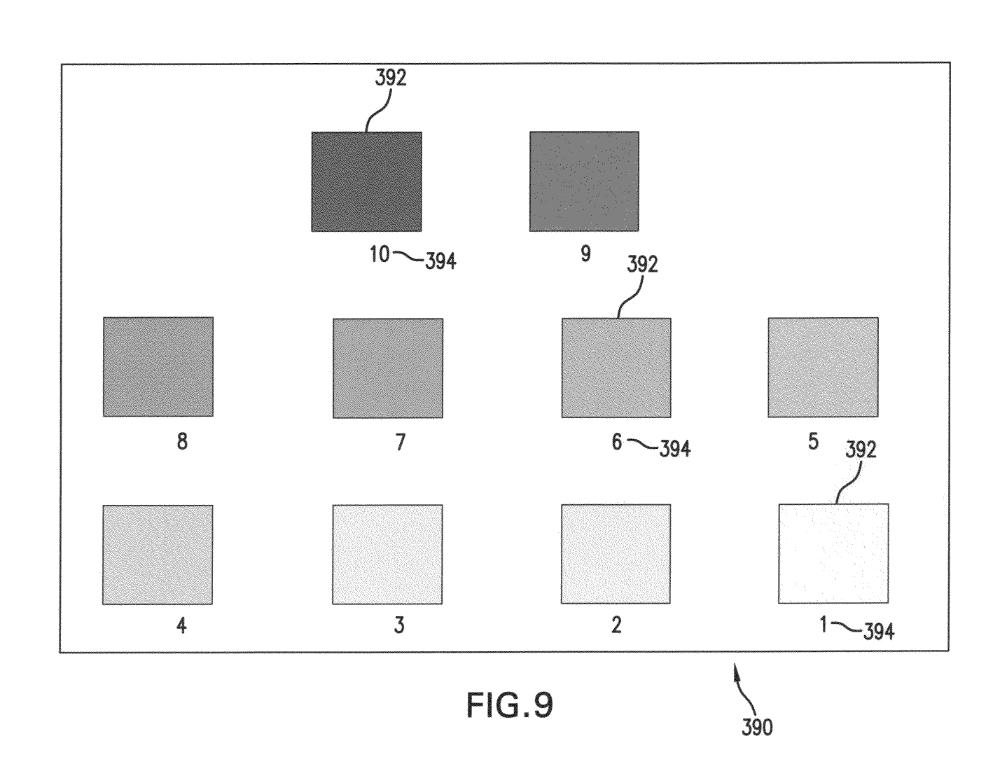

FIG. 9 shows an example fond color/darkness chart 390 with ten progressively darker colors 392, each having a corresponding indicia 394 (e.g., numerals, letters, alphanumeric characters, other characters or symbols, names, or a combination thereof). The fond colors 392 are graduated with each having a differing degree of darkness from most light to most dark. In this example, the fond color corresponding to indicia “1” is the lightest and has only a slight yellow/cream hue. The fond color corresponding to indicia “2” is slightly but noticeably darker and has a more yellowish hue. The fond color corresponding to indicia “3” is slightly but noticeably darker and has a darker yellow hue. The fond color corresponding to indicia “4” is slightly but noticeably darker and has a yellow/tan hue. The fond color corresponding to indicia “5” is slightly but noticeably darker and has a light tan hue. The fond color corresponding to indicia “6 is slightly but noticeably darker and has a dark tan/light brown hue. The fond color corresponding to indicia “7” is slightly but noticeably darker and has a light orange/brown hue. The fond color corresponding to indicia “8” is slightly but noticeably darker and has a medium orange/brown hue. The fond color corresponding to indicia “9” is slightly but noticeably darker and has a dark orange/brown hue. And the fond color corresponding to indicia “10” is slightly but noticeably darker and has a dark brown hue.

Generally, there is no need to record fond colors darker than the darkest color hue. When using the depicted fond color chart, for example, there is no need to record fond colors darker than that corresponding to indicia “10” (any fond that is darker could still be recorded as a “10”), as a darker color results in very little or no additional benefit. In alternative embodiments, the fond color/darkness chart can include more or fewer than ten fond colors/darknesses.

The depicted fond chart is provided in color and used to evaluate the color hue and/or darkness degree of the fond. In alternative embodiments, a fond chart can be provided in black and white, without colors, and used to evaluate the degree of darkness of the fond, without respect to the actual color hue.

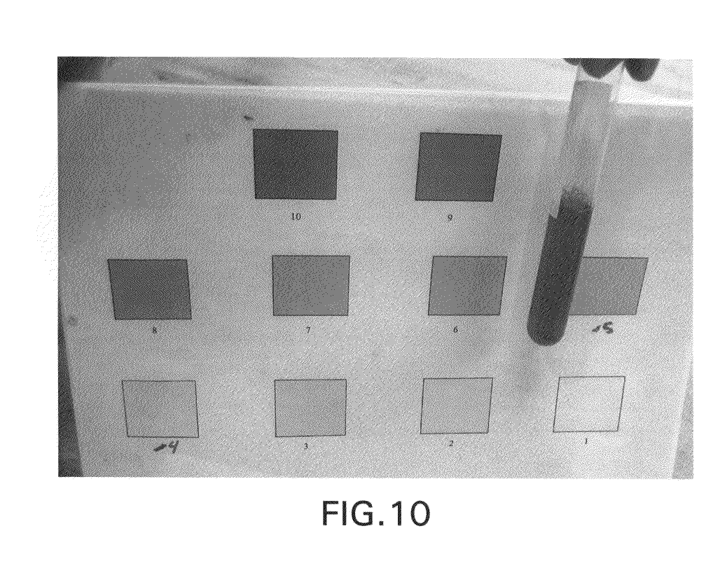

FIG. 10 shows a clear tube or vial containing the fond being compared to a fond color/darkness chart. The color and/or darkness most closely matching the fond color is identified by visual inspection, and then the color and/or darkness (or its corresponding indicia) is recorded by test personnel.

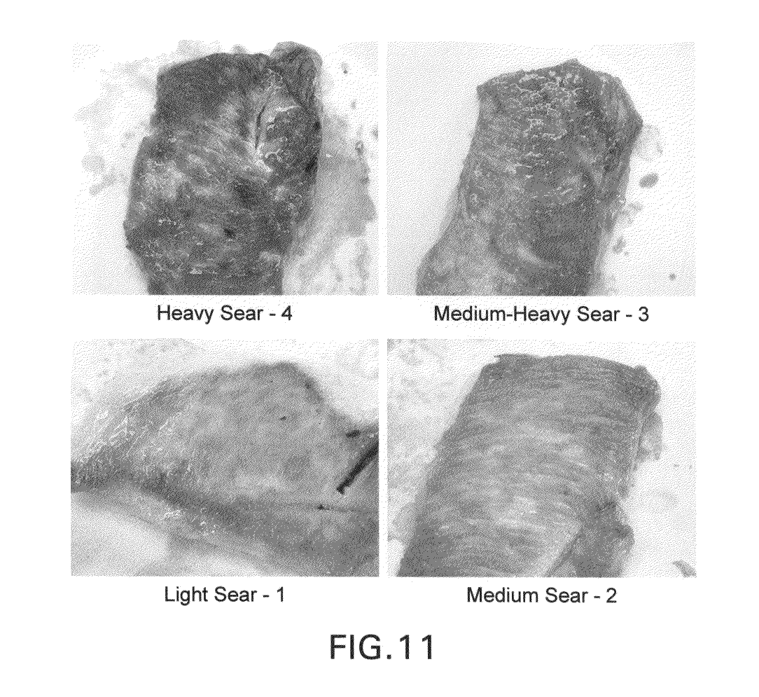

Going back to the set-aside chicken breast portion, at step 312 it is then evaluated for its color and/or darkness. The color/darkness of the seared chicken breast portion (e.g., of each side) is evaluated by comparing it to standardized sear colors or darknesses, for example on a chart, that are graduated into multiple progressively darker color hues or darkness degrees. For example, the sear color chart may include four color hues or darkness degrees, with each having a corresponding indicia, ranging from sear colors characterized as light (indicia “1”), medium (indicia “2”), medium-heavy (indicia “3”), and heavy (indicia “4”), as shown in FIG. 11. Alternatively, the sear color/darkness chart can include more or fewer than four sear colors. The color and/or darkness (or its corresponding indicia) most closely matching the color and/or darkness of the seared chicken breast portion is then recorded by test personnel. The depicted sear chart is provided in color and used to evaluate the color hue and/or darkness degree of the meat. In alternative embodiments, a sear chart can be provided in black and white, without colors, and used to evaluate the degree of darkness of the meat, without respect to the actual color hue.

It should be noted that the test method 300 can be performed with the step of forming the fond and evaluating its color/darkness but not the step of evaluating the color/darkness of the meat, with the step of evaluating the color/darkness of the meat but not the step of forming the fond and evaluating its color/darkness, or with both. The selection of evaluating the fond and/or the meat color/darkness in this test method can be made in part based upon the meat being tested, for example it may be more desirable to test fish by evaluating only the sear, as a fonds are not typically made from seared fish.

When recording these color/darkness evaluations, the following information may be noted: (a) the identity (e.g., model and specimen number) of the cookware test specimen; (b) the color/darkness (or corresponding indicia) most closely matching each seared side of the chicken portion; (c) the color/darkness (or corresponding indicia) most closely matching the fond; (d) the number of the test (if more than one test is performed on the same specimen); and (e) the tester's name and the date of the test.

The sear test can be repeated on the same cookware test specimen to confirm the test results for greater accuracy. In that case, the specimen can be cleaned before each subsequent test. The specimen may be soaked in warm, soapy water, the caramelized chicken residue gently scraped off using a cooking utensil (e.g., a nylon spatula for non-stick surfaces or a stainless steel spatula for all other surfaces), and lightly scrubbed using a scrub pad (e.g., a yellow, nylon DOBIE pad). After the cooking surface is clean, it may be gently dried (e.g., with a soft cotton towel).

In another aspect, the present invention relates to cookware that passes one, all, or only some of the test methods described herein. A cookware item that passes all of the herein-described test methods has a truly exceptional and unusual combination of excellent durability, nonstick, and searing characteristics. Such innovative high-quality cookware is highly desirable to cooking enthusiasts, whether home or commercial users.

It is to be understood that this invention is not limited to the specific devices, methods, conditions, or parameters described and/or shown herein, and that the terminology used herein is for the purpose of describing particular embodiments by way of example only. Thus, the terminology is intended to be broadly construed and is not intended to be unnecessarily limiting of the claimed invention. For example, as used in the specification including the appended claims, the singular forms “a,” “an,” and “one” include the plural, the term “or” means “and/or,” and reference to a particular numerical value includes at least that particular value, unless the context clearly dictates otherwise. In addition, any methods described herein are not intended to be limited to the specific sequence of steps described but can be carried out in other sequences, unless expressly stated otherwise herein.

While the invention has been shown and described in exemplary forms, it will be apparent to those skilled in the art that many modifications, additions, and deletions can be made therein without departing from the spirit and scope of the invention as defined by the following claims.

What is claimed is:

1. An accelerated-time test method for evaluating durability of an exterior grate-contacting bottom surface of a cookware test specimen, comprising:
a solution-soaking test phase including soaking at least a test area of the bottom surface in a caustic solution for a total soak time, wherein the caustic solution includes a caustic compound, and the concentration of the caustic compound in the caustic solution and the total soak time are selected to simulate a predefined lifetime of washings in an automatic dishwasher.

2. The test method of claim 1, wherein the concentration of the caustic compound and the total soak time are selected by using a methodology including defining the lifetime of use/abuse in terms of a number of automatic dishwasher cycles, deriving a formula for estimating the concentration based on a concentration of the caustic compound in water when used in automatic dishwashers, preparing the caustic solution according to the concentration formula, soaking at least one pre-test sample cookware item in the caustic solution for a predetermined test phase soak time, washing another pre-test sample cookware item in an automatic dishwasher a predetermined number of cycles, visually comparing the soaked sample to the automatic dishwashed sample, repeating the soak until the cooking surface of the soaked sample closely matches that of the automatic dishwashed sample, identifying the number of soaks required to obtain the match, and determining the total soak time by multiplying the number of soaks by the test phase soak time.

3. The test method of claim 1, wherein the caustic solution includes water and NaOH, the concentration of the NaOH in the caustic solution is about 0.04%, and the soak time is about 24 hours.

4. The test method of claim 1, further comprising at least one surface-degrading test phase for degrading at least the test area of the bottom surface.

5. The test method of claim 4, wherein the at least one surface-degrading test phase includes:
a heat-abrasion test phase including heating a grate of a cooking device and abrading at least the test area of the bottom surface on the grate;
a food-baking test phase including heating a cooking-surface staining food item, a food-cooking substance, or both on the test area of the bottom surface; or
a combination including the heat-abrasion test phase and the food-baking test phase.

6. The test method of claim 5, wherein the cooking-surface staining food item used in the food-baking test phase is tomato paste, yellow curry, or both.

7. The test method of claim 5, wherein the food-cooking substance used in the food-baking test phase is cooking oil.

8. A cookware item that passes the test method of claim 1.

9. An accelerated-time test method for evaluating durability of an exterior grate-contacting bottom surface of a cookware test specimen, comprising:
a heat-abrasion test phase including heating a grate of a cooking device and abrading at least the test area of the bottom surface on the grate;
a food-baking test phase including heating a cooking-surface staining food item, a food-cooking substance, or both on the test area of the bottom surface; and
a solution-soaking test phase including soaking at least a test area of the bottom surface in a caustic solution for a predetermined total soak time, wherein the caustic solution includes a caustic compound, wherein the concentration of the caustic compound in the caustic solution and the soak time are selected to simulate a predefined lifetime of washings in an automatic dishwasher, and wherein the concentration of the caustic compound and the total soak time are selected by using a methodology including defining the lifetime of use/abuse in terms of a number of automatic dishwasher cycles, deriving a formula for estimating the concentration based on a concentration of the caustic compound in water when used in automatic dishwashers, preparing the caustic solution according to the concentration formula, soaking at least one pre-test sample cookware item in the caustic solution for a predetermined test phase soak time, washing another pre-test sample cookware item in an automatic dishwasher a predetermined number of cycles, visually comparing the soaked sample to the automatic dishwashed sample, repeating the soak until the cooking surface of the soaked sample closely matches that of the automatic dishwashed sample, identifying the number of soaks required to obtain the match, and determining the total soak time by multiplying the number of soaks by the test phase soak time.

10. The test method of claim 9, wherein the caustic solution includes water and NaOH, the concentration of the NaOH in the caustic solution is about 0.04%, and the soak time is about 24 hours.

11. The test method of claim 9, wherein the cooking-surface staining food item used in the food-baking test phase is tomato paste, yellow curry, or both.

12. The test method of claim 9, wherein the food-cooking substance used in the food-baking test phase is cooking oil.

13. A cookware item that passes the test method of claim 9.

14. An accelerated-time test method for evaluating release performance of a nonstick cooking surface of a cookware test specimen, comprising:
an initial release test phase using a food item that tends to stick to cooking surfaces;
a food-baking test phase including heating salt and a greasy food item on the nonstick cooking surface;
a tiger paw test phase including abrading the nonstick cooking surface with at least one impact tip;
an automatic dishwasher test phase including washing the specimen in an automatic dishwasher for at least one cycle;
a concluding release test phase using a surface-sticking food item of the same type as used in the initial release test phase,

15. The test method of claim 21, wherein the initial and concluding release test phases include using a rating scale with more than two ratings and rating the release performance of the nonstick cooking surface more specifically than pass or fail by using the rating scale.

16. A cookware item that passes the test method of claim 14.

17. A sear test method for evaluating searing performance of a cooking surface of a cookware test specimen, comprising:
searing a piece of meat on the cooking surface;
removing the meat piece from the cooking surface, while leaving cooked-on meat residue on the cooking surface;
mixing a liquid with the meat residue to form a fond; and
evaluating a color or darkness of the fond against a plurality of standardized fond colors or darknesses.

18. The test method of claim 17, wherein the standardized fond colors or darknesses have progressively darker color hues, darkness degrees, or both.

19. The test method of claim 17, further comprising evaluating a color of the seared meat against a plurality of standardized sear colors or darknesses.

20. A cookware item that passes the test method of claim 17.
